(19) United States
(12) Patent Application Publication
(10) Pub. No.: US 2025/0301074 A1
(43) Pub. Date: Sep. 25, 2025

(54) RECORDING MEDIUM, METHOD, AND TERMINAL APPARATUS

(71) Applicant: CANON KABUSHIKI KAISHA, Tokyo (JP)

(72) Inventor: SHINYA YAMAZAKI, Kanagawa (JP)

(21) Appl. No.: 19/084,198

(22) Filed: Mar. 19, 2025

(30) Foreign Application Priority Data
Mar. 22, 2024 (JP) 2024-046230

(51) Int. Cl. H04N 1/00

(52) U.S. Cl. CPC H04N 1/00344; H04N 1/00244; H04N 1/00474; H04N 1/0048; H04N 1/00506

(57) ABSTRACT

A non-transitory computer-readable storage medium storing one or more programs configured to cause one or more computers to perform a method includes acquiring registration information indicating whether an external information processing apparatus is registered with a specific service provided for the information processing apparatus, performing control to display a first screen including a first selection item for instructing the information processing apparatus to execute a predetermined operation and a second selection item for instructing the information processing apparatus to execute a specific process for registering with the specific service in case that the registration information indicates that the information processing apparatus is not registered with the specific service, and performing control to display a second screen including the first selection item and not including the second selection item in case that the registration information indicates that the information processing apparatus is registered with the specific service.

### CROSS-REFERENCE TO RELATED APPLICATION

This application claims the benefit of Japanese Patent Application No. 2024-46230, filed Mar. 22, 2024, which is hereby incorporated by reference wherein in its entirety.

### BACKGROUND

### Field

The present disclosure relates to a recording medium, a method, and a terminal apparatus.

### Description of the Related Art

In recent years, a process according to the state of an information processing apparatus as a target, such as an image forming apparatus, may have been performed. Japanese Patent Laid-Open No. 2017-049767 discloses that, in a state in which a contract has been made for a delivery service of ink cartridges for a specific printer, an ink cartridge to be used in the target printer is shipped when the remaining amount of ink in the target printer falls below a threshold value.

Examples of states of an information processing apparatus as a target include a first state in which the information processing apparatus is not registered with a specific service, and a second state in which the information processing apparatus is registered with a specific service. It is necessary for a user to be able to appropriately register for and use services depending on the state of such an information processing apparatus.

### SUMMARY

According to an aspect of the present disclosure, there is provided a non-transitory computer-readable storage medium storing one or more programs configured to cause one or more computers to perform a method includes acquiring registration information indicating whether or not an information processing apparatus external to a terminal apparatus is registered with a specific service provided for the information processing apparatus, the specific service being a service provided by using an external server system, performing control on a display of the terminal apparatus to display a first screen including a first selection item for instructing the information processing apparatus to execute a predetermined operation and a second selection item for instructing the information processing apparatus to execute a specific process for registering with the specific service in case that the registration information indicates that the information processing apparatus is not registered with the specific service, and performing control on the display to display a second screen including the first selection item and not including the second selection item in case that the registration information indicates that the information processing apparatus is registered with the specific service.

Further features of the present disclosure will become apparent from the following description of embodiments with reference to the attached drawings.

### BRIEF DESCRIPTION OF THE DRAWINGS

FIG. 1 is a diagram illustrating an example of an overall configuration of a state management system.

FIG. 2 is a diagram illustrating an example of a configuration of a management server.

FIG. 3 is a diagram illustrating the contents of an account table and an apparatus registration table.

FIG. 4 is a hardware configuration diagram of a terminal apparatus.

FIG. 5 is a diagram illustrating an example of a functional configuration of the terminal apparatus.

FIG. 6 is a diagram illustrating a status management table.

FIG. 7 is a diagram illustrating an example of a reception screen.

FIG. 8 is a flowchart illustrating a flow of a registration reception process.

FIG. 9 is a diagram illustrating a web page displayed on a display unit through the registration reception process.

FIG. 10 is a diagram illustrating a registration status screen.

FIG. 11 is a flowchart illustrating a flow of an image determination process.

FIG. 12 is a diagram illustrating the reception screen for a printer with an apparatus ID of “P02.”

FIG. 13 is a diagram illustrating the reception screen for a printer with an apparatus ID of “P03.”

FIG. 14 is a diagram illustrating the reception screen for a printer with an apparatus ID of “P04.”

FIG. 15 is a diagram illustrating a customization screen.

FIG. 16 is a diagram illustrating the customization screen.

FIG. 17 is a diagram illustrating the customization screen.

FIG. 18 is a diagram illustrating a selection screen.

FIG. 19 is a diagram illustrating the customization screen.

FIGS. 20A to 20C are diagrams illustrating the reception screen for each printer.

FIGS. 21A and 21B are diagrams illustrating a modification example of the reception screen.

### DESCRIPTION OF THE EMBODIMENTS

An embodiment of the present disclosure will be described below with reference to the drawings.

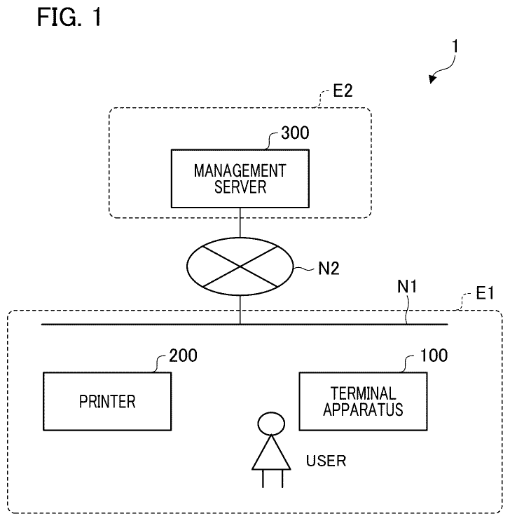

FIG. 1 is a diagram illustrating an example of an overall configuration of a state management system 1. The state management system 1 is a system that manages the state of a printer 200 provided in the state management system 1, as a target. An example of a state of the printer 200 as a target includes whether or not a service provided to a user for the printer 200 has been registered for the user. Furthermore, an example of a service provided to a user for the printer 200 includes a service in which ink cartridges are provided to the user according to the amount of ink remaining in the printer 200. The state management system 1 includes the printer 200, a management server 300, and a terminal apparatus 100. The environments in which the state management system 1 is provided include a user environment E1 and a remote environment E2. The user environment E1 is an environment in which a user can operate apparatuses provided in the state management system 1. The remote environment E2 is an environment in which the user cannot operate apparatuses provided in the state management system 1, which are located at a remote place from the user's position.

The printer 200, which is an example of an information processing apparatus, is an image forming apparatus that is provided in the user environment E1 and consumes ink as a consumable material to form an image on a recording medium. When the ink in the printer 200 runs out, the user removes the ink cartridge, which is a storage device that stores the ink, and replaces it with a new ink cartridge. In the present embodiment, the printer 200 will be described as an inkjet printer that prints by an inkjet method in which ink is ejected onto a paper surface. However, the printer 200 may be an apparatus that prints using a method other than the inkjet method, such as an electrophotographic method.

The terminal apparatus 100, which is an example of a management apparatus, is an apparatus used by a user for viewing information according to the state of the printer 200 as a target, for operating the printer 200, and the like. The terminal apparatus 100 is provided in the user environment E1. The terminal apparatus 100 may be a general-purpose terminal apparatus such as a smartphone, a mobile phone, a personal computer (PC), or a personal digital assistant (PDA).

The printer 200 and the terminal apparatus 100 are connected via a local network N1, such as the Internet, a local area network (LAN), or a wide area network (WAN). The printer 200 and the terminal apparatus 100 are connected to the management server 300 via the local network N1 and an external network N2. The external network N2 may be, for example, the Internet or a virtual private network (VPN). Furthermore, the local network N1 and the external network N2 may include communication apparatuses such as routers, switches, gateways, wireless access points, and base stations. Furthermore, the number of communication apparatuses included in the local network N1 and the external network N2 may be one or more.

The management server 300 is a server apparatus that manages information about the printer 200 and users. The management server 300 of the present embodiment manages information about the printer 200 and users for each user of the state management system 1. The management server 300 may be configured as a single computer, or may be realized by distributed processing using a plurality of computers. Furthermore, the management server 300 may be realized on virtual hardware provided by cloud computing. Furthermore, part of the information managed by the management server 300 may be managed by an apparatus other than the management server 300, such as a storage apparatus.

In the illustrated example, the number of printers 200 and terminal apparatuses 100 provided in the state management system 1 is one, but the number of printers 200 and terminal apparatuses 100 provided in the state management system 1 may be any number.

In the following, a case will be described in which the service provided to the user for the printer 200 is a service in which ink cartridges are provided to the user according to the amount of ink remaining in the printer 200, as described above. In this case, the printer 200 is provided with a detection unit (not illustrated) for detecting the remaining amount of ink, and when the detection means detects the remaining amount of ink, it transmits information indicating the detected remaining amount of ink to the management server 300. The management server 300 sends a new ink cartridge to the user before the ink runs out, depending on the amount of ink remaining in the printer 200 specified from the acquired information. The service of providing ink cartridges to users according to the amount of ink remaining in the printer 200 may hereinafter be referred to as a cartridge provision service.

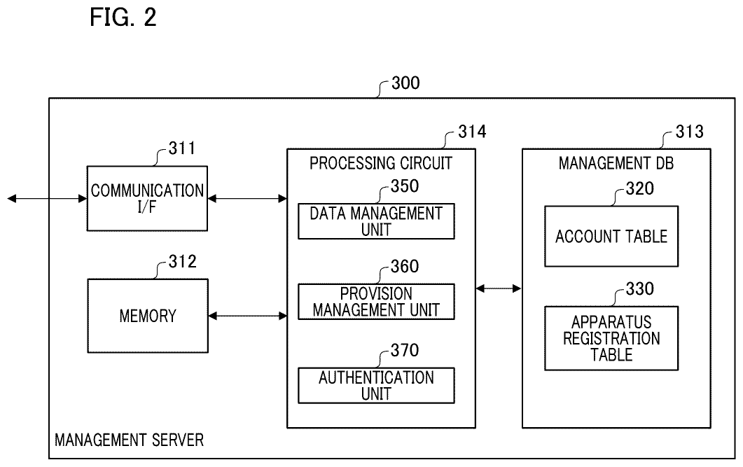

FIG. 2 is a diagram illustrating an example of a configuration of the management server 300. The management server 300 includes a communication interface (I/F) 311, a memory 312, a management database (DB) 313, and a processing circuit 314.

The communication I/F 311 is an interface for the management server 300 to communicate with other apparatuses such as the printer 200 and the terminal apparatus 100. The communication I/F 311 for the management server 300 to communicate with other apparatuses may be configured as a wired or wireless communication interface.

The memory 312 stores one or more computer programs executed by the processing circuit 314, information transmitted to the management server 300, and the like. Examples of the memory 312 include semiconductor memories such as a read only memory (ROM) or a random access memory (RAM), and storage media such as optical discs and magnetic disks. Furthermore, the number of storage media provided in the memory 312 may be one or more. The memory 312 may also include a non-transitory computer-readable storage medium.

The management DB 313 is a database that manages information about one or more printers 200 that are targets of management by the state management system 1. The printer 200 that is the target of management by the state management system 1 may hereinafter be referred to as the printer 200 to be managed. The management DB 313 includes an account table 320 and an apparatus registration table 330.

The account table 320 is a table showing information about users who use the printers 200 to be managed.

The apparatus registration table 330 is a table showing information about the printers 200 to be managed. The contents of the information shown in the account table 320 and the apparatus registration table 330 will be described in detail later.

The processing circuit 314 is, for example, a central processing unit (CPU) or the like, and realizes each process of the management server 300 by executing computer programs stored in the memory 312. The processing circuit 314 includes a data management unit 350, a provision management unit 360, and an authentication unit 370.

The data management unit 350 manages the information shown in the management DB 313. When the data management unit 350 acquires information about a user who uses the printer 200 to be managed from the terminal apparatus 100 via the communication I/F 311, the data management unit 350 writes the acquired information in the account table 320. Furthermore, when the data management unit 350 acquires information indicating the remaining amount of ink from a detection unit (not illustrated) of the printer 200 via the communication I/F 311, the data management unit 350 writes the acquired information in the apparatus registration table 330. Furthermore, when the data management unit 350 acquires information about the user who uses the printer 200 to be managed or information indicating the remaining amount of ink, the data management unit 350 updates the contents of the account table 320 and the apparatus registration table 330 according to the acquired information.

The provision management unit 360 manages the provision of ink cartridges by the cartridge provision service. When the remaining amount of ink shown in the apparatus registration table 330 for the printer 200 to be managed falls below a predetermined value, the provision management unit 360 notifies the user of the printer 200 to ship an ink cartridge. The destination of this notification may be the person who ships the ink cartridge, or the person who requests the shipping of the ink cartridge.

The authentication unit 370 authenticates the user who uses the printer 200 to be managed. User authentication includes processing such as password authentication for a user attempting to log in to the state management system 1 via the terminal apparatus 100.

In this way, the management server 300 manages information about users of the state management system 1, the amount of ink remaining in the target printers 200 registered in the cartridge provision service, and the like.

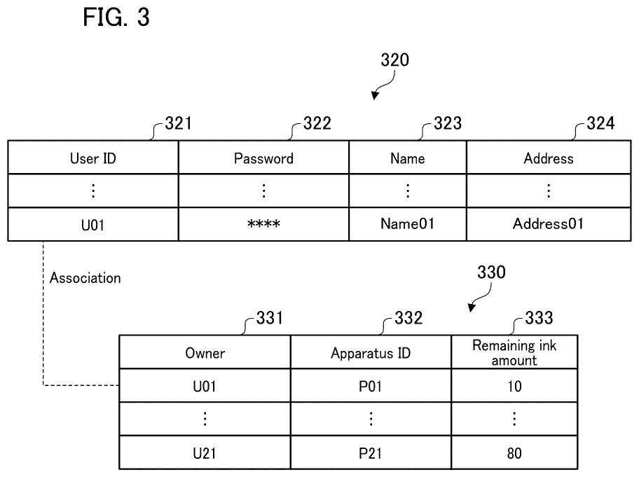

FIG. 3 is a diagram illustrating the contents of the account table 320 and the apparatus registration table 330.

The contents of the account table 320 will be described in detail. The account table 320 shows a user ID 321, a password 322, a name 323, and an address 324.

The user ID 321 is information for identifying a user who uses the printer 200 to be managed. The password 322 is a password used by the authentication unit 370 to authenticate the user. The name 323 is a name of the user who uses the printer 200 to be managed. The address 324 is an address used for shipping the ink cartridges in the cartridge provision service.

The contents of the apparatus registration table 330 will be described in detail. The apparatus registration table 330 shows an owner 331, an apparatus ID 332, and a remaining ink amount 333.

The owner 331 is information for identifying the owner of the printer 200 to be managed. In the illustrated example, the owner 331 indicates the same information as the user ID 321 in the account table 320. The apparatus ID 332 is information for identifying the printer 200 to be managed. The remaining ink amount 333 is a value detected by a detection unit (not illustrated) as the remaining ink amount in the printer 200 to be managed. The remaining ink amount 333 may be expressed as a percentage. Furthermore, the remaining ink amount 333 may be shown for each ink color.

The information shown in the account table 320 and the information shown in the apparatus registration table 330 are stored in association with each other. As an example, the information “U01,” “****,” “Name01,” and “Address01” in the account table 320 are associated with the information “U01,” “P01,” and “10” in the apparatus registration table 330. Note that one user ID 321 in the account table 320 may be associated with an owner 331, an apparatus ID 332, and a remaining ink amount 333 for a plurality of printers 200 to be managed in the apparatus registration table 330.

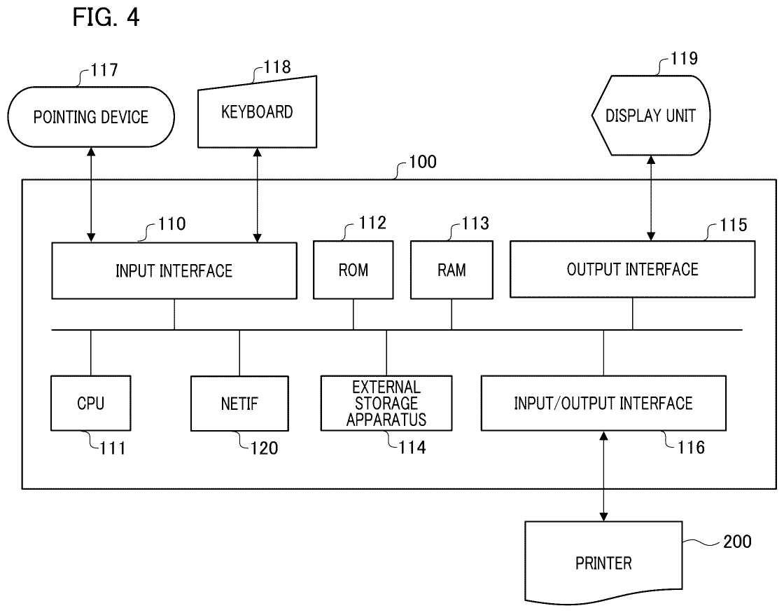

FIG. 4 is a hardware configuration diagram of the terminal apparatus 100. The terminal apparatus 100 includes an input interface 110, a CPU 111, a ROM 112, a RAM 113, an external storage apparatus 114, an output interface 115, an input/output interface 116, and a network interface (NETIF) 120. The input interface 110 is connected to input devices such as a keyboard 118 and a pointing device 117, and the output interface 115 is connected to a display device such as a display unit 119. The NETIF 120 controls data transfer between external devices via a network. In the illustrated example, the display unit 119, the pointing device 117, and the keyboard 118 are described as examples of devices separate from the terminal apparatus 100, but these may also be included in the terminal apparatus 100. In case that the display unit 119 is a device separate from the terminal apparatus 100, the display unit 119 is regarded as an example of a display apparatus. Furthermore, in case that the display unit 119 is included in the terminal apparatus 100, the terminal apparatus 100 is regarded as an example of a display apparatus. Furthermore, the display unit 119 may be a touch panel display having a function as an input/output device. The ROM 112 stores an initialization program. The external storage apparatus 114 stores a group of application programs, an operating system (OS), print data generation software, and various types of other data. The RAM 113 is used as a work memory or the like when various programs stored in the external storage apparatus 114 are executed, thereby enabling the various programs to operate within the terminal apparatus 100. In the present embodiment, the CPU 111 executes processes according to the procedures of a program stored in the ROM 112, thereby executing the functions and processes described below in the terminal apparatus 100. The input/output interface 116 may be wired or wireless.

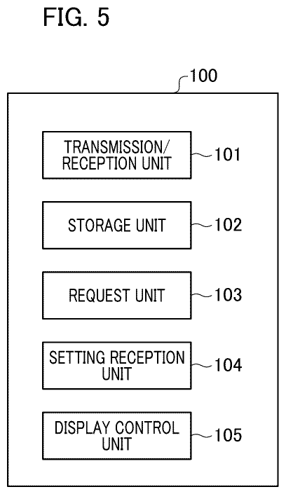

FIG. 5 is a diagram illustrating an example of a functional configuration of the terminal apparatus 100.

The terminal apparatus 100 includes a transmission/reception unit 101, a storage unit 102, a request unit 103, a setting reception unit 104, and a display control unit 105.

The transmission/reception unit 101, which is an example of an acquisition function (acquisition unit), transmits and receives information to and from apparatuses external to the terminal apparatus 100, such as the management server 300 and the printer 200.

The storage unit 102 stores information received by the transmission/reception unit 101 and information generated by the terminal apparatus 100. The contents of the information stored in the storage unit 102 will be described in detail later.

The request unit 103 requests information from the management server 300 and the printer 200. The request unit 103 requests the management server 300 for information required for registration in the cartridge provision service. Furthermore, the request unit 103 requests, from the printer 200, information indicating whether or not the printer 200 is a printer 200 to which the cartridge provision service is applied because it is registered with the cartridge provision service. Note that the printer 200 to which the cartridge provision service is applied because it is registered with the cartridge provision service may hereinafter be referred to as the applicable printer 200.

The setting reception unit 104, which is an example of a reception function, receives a setting by a user as to whether or not information is to be displayed on the terminal apparatus 100.

The display control unit 105, which is an example of a screen display function (image display function), performs control the display of information on the display unit 119. The display control unit 105 requests information indicating whether or not the printer 200 is an applicable printer 200 via the request unit 103 to the printer 200, and acquires the requested information from the printer 200 via the transmission/reception unit 101. In case that the printer 200 is not an applicable printer 200, the display control unit 105 displays, on the display unit 119, a display item (image) that receives registration for the cartridge provision service for this printer 200. On the other hand, in case that the printer 200 is an applicable printer 200, the display control unit 105 does not display an image that receives registration for the cartridge provision service, but instead displays information corresponding to the fact that the printer 200 is an applicable printer 200. Furthermore, the display control unit 105 displays, for each printer 200 for which information is to be displayed on the display unit 119, information according to whether or not this printer 200 is an applicable printer 200.

Note that, in case that the printer 200 is not one of the apparatuses for which registration for the cartridge provision service is possible, the display control unit 105 does not display an image that receives registration for the cartridge provision service. Furthermore, there are cases where the setting reception unit 104 has received that the image that receives registration for the cartridge provision service is not displayed. In this case, the display control unit 105 does not display the image that receives registration for the cartridge provision service, regardless of whether the printer 200 is an applicable printer 200.

Here, the transmission/reception unit 101 is realized by the input/output interface 116 illustrated in FIG. 4. The storage unit 102 is realized by the ROM 112 or the RAM 113 illustrated in FIG. 4. The request unit 103, the setting reception unit 104, and the display control unit 105 are realized by the CPU 111 illustrated in FIG. 4 loading programs from the ROM 112 into the RAM 113 and executing them.

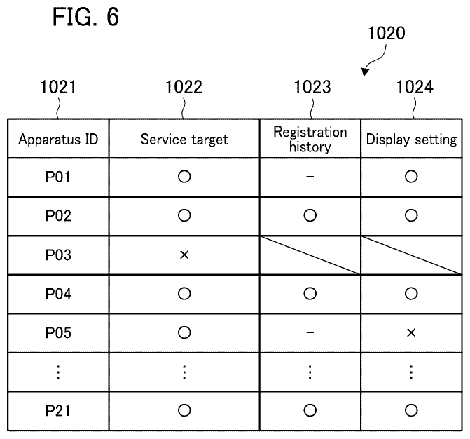

FIG. 6 is a diagram illustrating a status management table 1020. The status management table 1020 is a table for managing the status of the printer 200 regarding the cartridge provision service. The status management table 1020 is stored in the storage unit 102 (see FIG. 5) of the state management system 1. The status management table 1020 also shows an apparatus ID 1021, a service target 1022, a registration history 1023, and a display setting 1024.

The apparatus ID 1021 is information for identifying the printer 200 to be managed. The information shown in the apparatus ID 1021 of the status management table 1020 is the same as the information shown in the apparatus ID 332 of the apparatus registration table 330 (see FIG. 3).

The service target 1022 is information for identifying whether or not the printer 200 is one of the apparatuses for which registration for the cartridge provision service is possible. The “o” shown in the service target 1022 means that the printer 200 is one of the apparatuses for which registration for the cartridge provision service is possible. Moreover, the “x” shown in the service target 1022 means that the printer 200 is not one of the apparatuses for which registration for the cartridge provision service is possible. In the service target 1022, as information indicating whether or not the printer 200 is one of the apparatuses for which registration for the cartridge provision service is possible, the content corresponding to the information transmitted from the printer 200 to the transmission/reception unit 101 is written by the display control unit 105.

The registration history 1023 is information indicating the registration history of the cartridge provision service. The “o” shown in the registration history 1023 means that there is a registration history of the cartridge provision service. Moreover, the “-” shown in the registration history 1023 means that there is no registration history of the cartridge provision service. In the registration history 1023, as information indicating the registration history of the cartridge provision service, the content corresponding to the information transmitted from the printer 200 to the transmission/reception unit 101 is written by the display control unit 105.

In addition, information indicating whether or not the printer 200 is one of the apparatuses for which registration for the cartridge provision service is possible, and information indicating the registration history of the cartridge provision service may be generated by the management server 300 and transmitted from the management server 300 to the terminal apparatus 100.

The display setting 1024 is information for identifying a setting as to whether or not to display an image that receives registration for the cartridge provision service. The “o” shown in the display setting 1024 means that an image that receives registration for the cartridge provision service is set to be displayed. Moreover, the “x” shown in the display setting 1024 means that an image that receives registration for the cartridge provision service is set not to be displayed. In the display setting 1024, the content received by the setting reception unit 104 in response to a user operation regarding whether or not information is to be displayed on the terminal apparatus 100 is written by the setting reception unit 104.

An example of the contents written in the status management table 1020 will be described. In the status management table 1020 for the printer 200 with an apparatus ID 1021 of “P01,” “o” is associated as the service target 1022, “-” is associated as the registration history 1023, and “o” is associated as the display setting 1024.

The information shown in the status management table 1020 may be information input into the terminal apparatus 100 by the user.

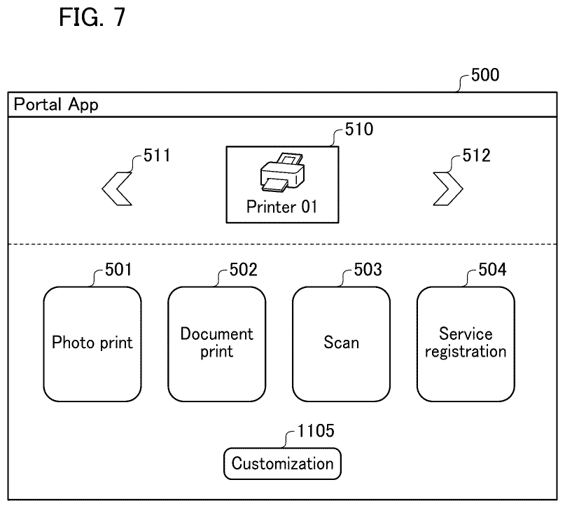

FIG. 7 is a diagram illustrating an example of a reception screen 500. The reception screen 500 is a screen for receiving operations by a user for using the printer 200. The reception screen 500 is displayed on the display unit 119. The reception screen 500 displays a target image 510, a previous button 511, a next button 512, a photo print button 501, a document print button 502, a scan button 503, a registration button 504, and a customization button 1105.

The target image 510 is an image showing the printer 200 for which information is to be displayed on the reception screen 500. The printer 200 for which information is to be displayed on the reception screen 500 may hereinafter be referred to as the printer 200 to be displayed. In the illustrated example, the target image 510 displays the text “Printer 01” which indicates the printer 200 to be displayed.

The previous button 511 is a button for receiving the setting of a printer 200 whose apparatus ID 1021 in the status management table 1020 (see FIG. 6) is one printer before the printer 200 to be displayed as a new printer 200 to be displayed. The next button 512 is a button for receiving the setting of a printer 200 whose apparatus ID 1021 is one printer after the printer 200 to be displayed as a new printer 200 to be displayed.

The photo print button 501 is a button for receiving printing of a photo by the printer 200. When the user presses the photo print button 501, the user selects a photo to be printed, and then the selected photo is printed by the printer 200.

The document print button 502 is a button for receiving printing of a document by the printer 200. When the user presses the document print button 502, the user selects a document to be printed, and then the selected document is printed by the printer 200.

The scan button 503 is a button for receiving scanning of an image by the printer 200. When the user presses the scan button 503, the user selects an image to be scanned, and then the image is scanned into the printer 200.

The registration button 504, which is an example of a display item, is a button for receiving registration for a cartridge provision service for the printer 200 to be displayed. Although details will be described later, when the user presses the registration button 504, the user inputs information into the terminal apparatus 100, and then the cartridge provision service for the printer 200 to be displayed is registered. In the status management table 1020 (see FIG. 6), the target information shown in the display setting 1024 for setting whether or not to display is the registration button 504.

The customization button 1105 is a button for receiving settings as to whether or not information is to be displayed on the reception screen 500.

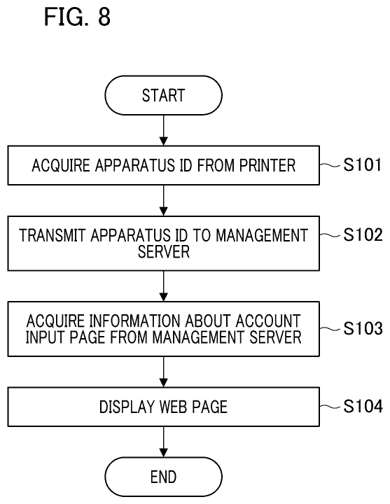

FIG. 8 is a flowchart illustrating a flow of a registration reception process. The registration reception process is a process for receiving registration for the cartridge provision service. The registration reception process is performed by the terminal apparatus 100. In the present embodiment, when the user presses the registration button 504 (see FIG. 7), the registration reception process is started.

The display control unit 105 of the terminal apparatus 100 requests information for identifying the printer 200 from the printer 200 to be displayed via the request unit 103, and acquires the apparatus ID 332 (see FIG. 3) from the printer 200 via the transmission/reception unit 101 (S101).

The display control unit 105 transmits the acquired apparatus ID 332 to the management server 300 via the transmission/reception unit 101 (S102).

The display control unit 105 acquires information about a web page that receives an input of an account for the printer 200 specified from the transmitted apparatus ID 332 from the data management unit 350 of the management server 300 via the transmission/reception unit 101 (S103). Furthermore, the display control unit 105 displays the acquired web page on the display unit 119 (S104).

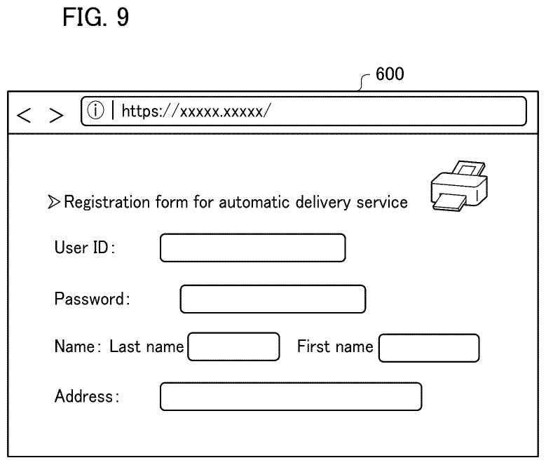

FIG. 9 is a diagram illustrating a web page 600 displayed on the display unit 119 through the registration reception process. The web page 600 is an image that receives an input of the account of the owner of the printer 200. When information is input into the web page 600, the transmission/reception unit 101 of the terminal apparatus 100 transmits the input information to the management server 300. The data management unit 350 of the management server 300 writes the information acquired from the transmission/reception unit 101 via the communication I/F 311 in the account table 320 (see FIG. 3) in association with the target apparatus ID 332. As a result, the account associated with the printer 200 is stored in the account table 320, registration for the cartridge provision service is completed, and delivery of the ink cartridges becomes possible. In this way, by registering the cartridge provision service via the management server 300, the burden on the user required for registering the cartridge provision service is reduced.

The image that receives the account input is not limited to the web page 600, and may be an image of any type. In addition, the account input by the user of the terminal apparatus 100 may be valid only for the period during which the user is logged in to the state management system 1 by successful user authentication using the user ID and password stored in the account table 320.

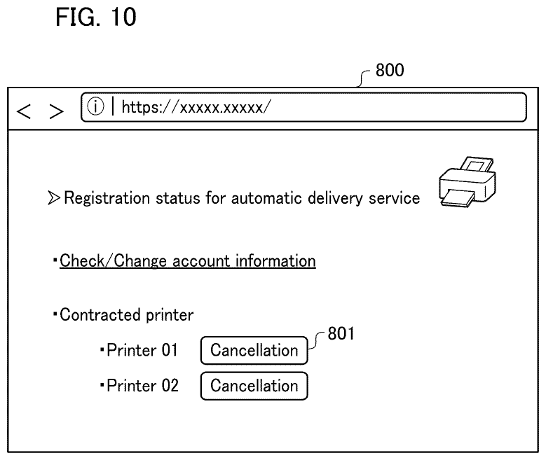

FIG. 10 is a diagram illustrating a registration status screen 800. The registration status screen 800 is an image showing the registration status of the cartridge provision service for each user. The registration status screen 800 is displayed on the display unit 119 in case that any of the printers 200 is registered with the cartridge provision service. Furthermore, the registration status screen 800 displays a cancel button 801. The cancel button 801 is a button for receiving cancellation of registration for the cartridge provision service. When the user presses the cancel button 801, the management server 300 is notified of via the terminal apparatus 100 that the cancel button 801 has been pressed. In this case, the data management unit 350 deletes the information shown in the apparatus registration table 330 (see FIG. 3) for the printer 200 for which the cancel button 801 was pressed, thereby cancelling the registration of this printer 200 for the cartridge provision service. The data management unit 350 may cancel the registration of the printer 200 for the cartridge provision service by deleting the information shown in the account table 320 for the printer 200 for which the cancel button 801 was pressed. In addition, the data management unit 350 may cancel the registration for the cartridge provision service without deleting the information in the account table 320 or the apparatus registration table 330 by writing information indicating that the cancel button 801 has been pressed into the apparatus registration table 330.

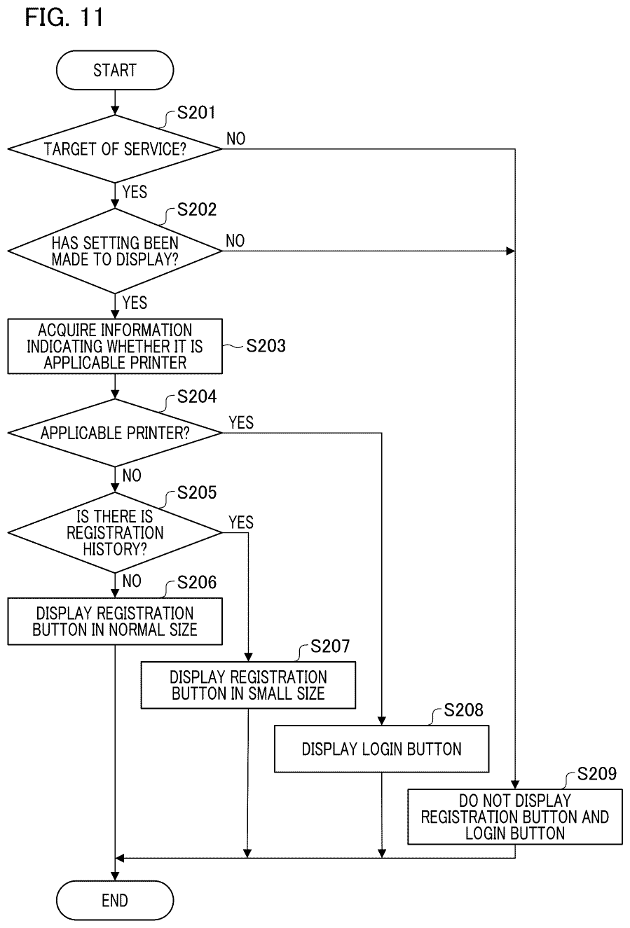

FIG. 11 is a flowchart illustrating a flow of an image determination process. The image determination process is a process in which the display control unit 105 of the terminal apparatus 100 determines which image is to be displayed on the reception screen 500 (see FIG. 7) for the printer 200 to be displayed. In the present embodiment, when an instruction to display the reception screen 500 for one printer 200 to be managed on the display unit 119 is received, for example, by a user operating the terminal apparatus 100, the image determination process is started. In the present embodiment, the CPU 111 (see FIG. 4) of the terminal apparatus 100 loads a program stored in the ROM 112 into the RAM 113 and executes the program, thereby implementing each process in the image determination process.

The display control unit 105 determines whether or not the printer 200 to be displayed is one of the apparatuses for which registration for the cartridge provision service is possible (S201). The display control unit 105 requests the management server 300, via the request unit 103, for information indicating whether or not the printer 200 to be displayed is one of the apparatuses for which registration for the cartridge provision service is possible. Furthermore, when the display control unit 105 acquires the requested information from the management server 300 via the transmission/reception unit 101, the display control unit 105 determines whether or not the printer 200 to be displayed is one of the apparatuses for which registration for the cartridge provision service is possible.

When the display control unit 105 acquires information indicating whether or not the printer 200 to be displayed is one of the apparatuses for which registration for the cartridge provision service is possible, the display control unit 105 stores the acquired information in the storage unit 102. Then, in the next or subsequent image determination process for the same printer 200, the display control unit 105 determines whether or not the printer 200 is one of the apparatuses for which registration for the cartridge provision service is possible by referring to the information stored in the storage unit 102. In this case, in the second or subsequent image determination process for the same printer 200, there is no need for the terminal apparatus 100 to request information from the management server 300 in S201, and unnecessary communication between the terminal apparatus 100 and the management server 300 is suppressed.

Furthermore, the printer 200 may acquire, from the management server 300, information indicating whether or not the printer 200 to be displayed is one of the apparatuses for which registration for the cartridge provision service is possible, and then transmit this information to the terminal apparatus 100.

In case that the printer 200 to be displayed is one of the apparatuses for which registration for the cartridge provision service is possible (YES in S201), the process proceeds to the next step. The display control unit 105 determines whether or not a setting has been made to display the registration button 504 (see FIG. 7) for the printer 200 to be displayed (S202). The display control unit 105 determines whether or not the setting to display the registration button 504 has been made by referring to the information shown in the display setting 1024 of the status management table 1020 for the printer 200 to be displayed.

In case that the setting to display the registration button 504 has been made (YES in S202), the display control unit 105 acquires information indicating whether or not the printer 200 to be displayed is an applicable printer 200 from the printer 200 to be displayed (S203). Then, the display control unit 105 determines, from the acquired information, whether or not the printer 200 to be displayed is an applicable printer 200 (S204). Note that information indicating whether or not the printer 200 to be displayed is an applicable printer 200 may hereinafter be referred to as target identification information. In addition, the target identification information may be generated by the printer 200, or may be generated by the management server 300 and transmitted from the management server 300 to the printer 200. In case that the target identification information is generated by the management server 300, the timing at which the printer 200 requests the target identification information from the management server 300 may be when the printer 200 is activated, or when the terminal apparatus 100 requests the target identification information from the printer 200.

The target identification information is information indicating whether the printer 200 is in a first state (unregistered state) or a second state (registered state) with respect to the cartridge provision service. That is, the first state is a state in which the printer 200 is not a printer to which the cartridge provision service is applicable. In addition, the second state is a state in which the printer 200 is a printer to which the cartridge provision service is applicable.

Furthermore, in S203, the terminal apparatus 100 may acquire, together with the target identification information, information indicating whether or not the printer 200 to be displayed is one of the apparatuses for which registration for the cartridge provision service is possible. In this case, in the image determination process, the process in S201 is performed after the process in S203.

In case that the printer 200 to be displayed is not an applicable printer 200 (NO in S204), the display control unit 105 determines whether or not there is a registration history of the cartridge provision service for the printer 200 to be displayed (S205). The display control unit 105 determines whether or not there is a registration history of the cartridge provision service by referring to the information shown in the registration history 1023 of the status management table 1020 for the printer 200 to be displayed.

In case that there is no registration history of the cartridge provision service (NO in S205), the display control unit 105 determines to display the registration button 504 in the normal size on the reception screen 500 (S206).

Furthermore, in case that there is a registration history of the cartridge provision service (YES in S205), the display control unit 105 determines to display the registration button 504 in the small size on the reception screen 500 (S207).

Furthermore, in case that the printer 200 to be displayed is the applicable printer 200 (YES in S204), the display control unit 105 determines to display a login button on the reception screen 500 without displaying the registration button 504 (S208). The login button will be described in detail later.

Furthermore, in case that a negative result is obtained in step 201 or step 202, the display control unit 105 determines not to display either the registration button 504 or the login button on the reception screen 500 (S209).

In case that the reception screen 500 (see FIG. 7) is displayed, the previous button 511 or the next button 512 may be pressed. In this case, the image determination process for a new printer 200 to be displayed by pressing the previous button 511 or the next button 512 is started.

As described above, in the image determination process, the terminal apparatus 100 acquires information about the printer 200 and determines an image to be displayed on the reception screen 500, with only the printer 200 to be displayed as a target. Therefore, compared to a case where one image determination process is performed for all the printers 200 managed by the state management system 1, the process of the terminal apparatus 100 is prevented from becoming complicated.

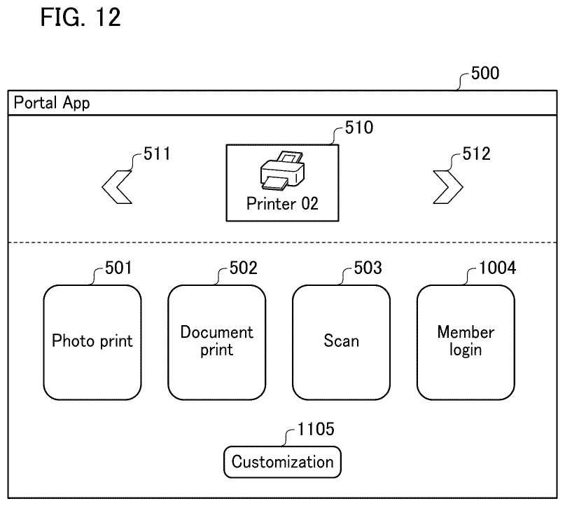

FIG. 12 is a diagram illustrating the reception screen 500 for the printer 200 with an apparatus ID 1021 (see FIG. 6) of “P02.” In the following, a case will be described in which the printer 200 with the apparatus ID 1021 of “P02” is the applicable printer 200. In this case, in the image determination process (see FIG. 11) for the printer 200 with the apparatus ID 1021 of “P02,” affirmative results are obtained in S201, S202, and S204.

On the reception screen 500 illustrated in FIG. 12, the target image 510 displays the text “Printer 02” which indicates the printer 200 to be displayed. Furthermore, on the reception screen 500, a login button 1004 is displayed instead of the registration button 504 (see FIG. 7). The login button 1004, which is an example of an information image, is a button for receiving a user's login to the state management system 1. When the user presses the login button 1004, the user's login to the state management system 1 is received, and the registration status screen 800 (see FIG. 10) is displayed. Therefore, the login button 1004 can also be regarded as an image for displaying information for users who have already registered with the cartridge provision service. In case that the user presses the login button 1004, user authentication is performed using the user ID and password stored in the account table 320, and in case that the authentication is successful, the registration status screen 800 may be displayed.

As described above, in case that it is specified from the target identification information that the state of the printer 200 as a target is the first state, the display control unit 105 causes the registration button 504 to be displayed on the reception screen 500 (see FIG. 7). Furthermore, in case that it is specified from the target identification information that the state of the printer 200 as a target is the second state, the display control unit 105 restricts the display of the registration button 504 on the reception screen 500 (see FIG. 12). An example of the first state includes a state in which the printer 200 is not an applicable printer 200. An example of the second state includes a state in which the printer 200 is an applicable printer 200. The target identification information can also be regarded as information about the state of the information processing apparatus as a target. The registration button 504 can also be regarded as a display item capable of executing a process for changing the state of the printer 200 as a target to the second state.

In this case, the user can appropriately register for and use the service. In particular, in the present embodiment, in case that the printer 200 is an applicable printer 200, the registration button 504 is not displayed on the reception screen 500. This prevents the user from feeling uncomfortable about being prompted to register with the cartridge provision service because the registration button 504 is displayed on the reception screen 500 even though the user has already registered with the cartridge provision service.

In particular, in the present embodiment, the state of the printer 200 as a target is whether or not the printer 200 is registered with a predetermined service. In other words, the first state is a state in which the printer 200 is not registered with a predetermined service, and the second state is a state in which the printer 200 is registered with a predetermined service. In this case, the user can appropriately register for the service.

In the present embodiment, the predetermined service is a service in which ink cartridges are provided. In this case, the user can appropriately register for the service for which the ink cartridge is provided.

Furthermore, in the present embodiment, in case that it is specified from the target identification information that the printer 200 is not registered with a predetermined service, the display control unit 105 causes the registration button 504 to be displayed on the reception screen 500. Furthermore, in case that it is specified from the target identification information that the printer 200 is registered with a predetermined service, the display control unit 105 restricts the display of the registration button 504 on the reception screen 500.

In this case, it is possible to switch between allowing the user to appropriately register for the service and preventing the user from feeling uncomfortable about being prompted to register with the service, depending on whether or not the printer 200 is registered with a predetermined service.

In the present embodiment, it has been described that the display control unit 105 does not display the registration button 504 on the reception screen 500 in case that the printer 200 to be displayed is not an applicable printer 200, but the present disclosure is not limited thereto. The display control unit 105 may provide a period during which the registration button 504 is not displayed on the reception screen 500 in case that the printer 200 to be displayed is not an applicable printer 200. In other words, the display control unit 105 may set the time for which the registration button 504 is displayed on the reception screen 500 to be shorter when the printer 200 to be displayed is not an applicable printer 200 than when the printer 200 to be displayed is an applicable printer 200. Note that shortening the time for which the registration button 504 is displayed on the reception screen 500 can be regarded as an example of restricting the display of the registration button 504 on the reception screen 500. The display control unit 105 can also be regarded as a restricting function (restricting unit) that restricts the display of the registration button 504 on the reception screen 500.

In addition, in case that it is specified from the target identification information that the state of the printer 200 as a target is the second state, the display control unit 105 causes the reception screen 500 to display the login button 1004 for providing information corresponding to the second state. In this case, information according to the state of the printer 200 as a target can be provided to the user.

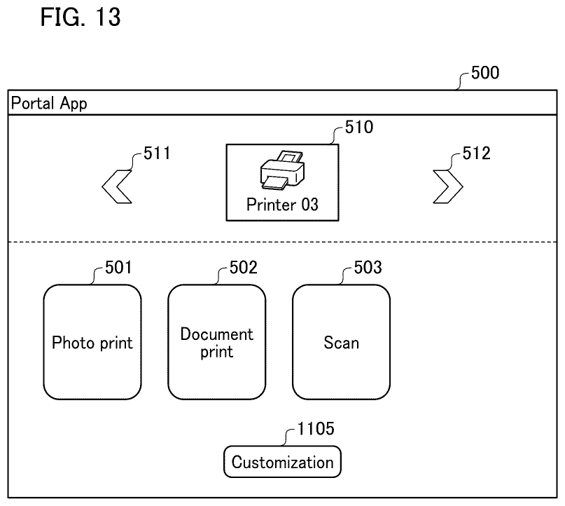

FIG. 13 is a diagram illustrating the reception screen 500 for the printer 200 with an apparatus ID 1021 (see FIG. 6) of “P03.” As indicated by the service target 1022 in the status management table 1020, this printer 200 is not one of the apparatuses for which registration for the cartridge provision service is possible. In this case, in the image determination process (see FIG. 11) for the printer 200 with the apparatus ID 1021 of “P03,” a negative result is obtained in S201.

On the reception screen 500 illustrated in FIG. 13, the target image 510 displays the text “Printer 03” which indicates the printer 200 to be displayed. Furthermore, neither the registration button 504 nor the login button 1004 is displayed on the reception screen 500. In other words, the reception screen 500 of a printer 200 that is not one of the apparatuses for which registration for the cartridge provision service is possible does not display information encouraging registration with the cartridge provision service or information corresponding to being registered for the cartridge provision service.

As described above, in case that the printer 200 is not one of the apparatuses for becoming the applicable printer 200, the display control unit 105 restricts the display of both the registration button 504 and the login button 1004 on the reception screen 500. In this case, it is possible to prevent the user from feeling uncomfortable about being notified of information related to the cartridge provision service for the printer 200 that is not one of the apparatuses for which registration for the cartridge provision service is possible.

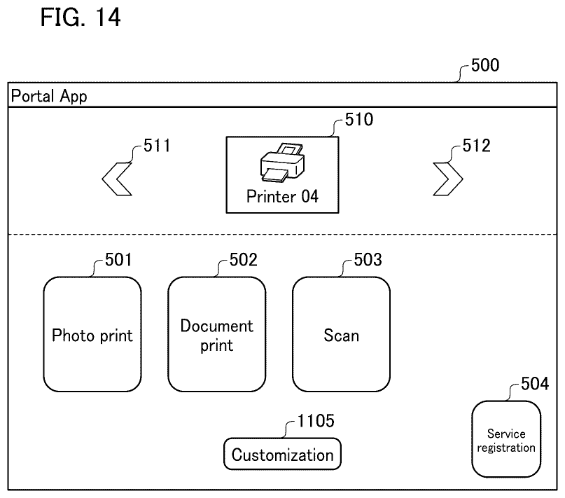

FIG. 14 is a diagram illustrating the reception screen 500 for the printer 200 with an apparatus ID 1021 (see FIG. 6) of “P04.” As indicated by the registration history 1023 in the status management table 1020, this printer 200 has a registration history of the cartridge provision service. In the following, a case will be described in which the printer 200 with the apparatus ID 1021 of “P04” is not the applicable printer 200. In this case, in the image determination process (see FIG. 11) for the printer 200 with the apparatus ID 1021 of “P04,” affirmative results are obtained in S201 and S202, a negative result is obtained in S204, and an affirmative result is obtained in S205.

On the reception screen 500 illustrated in FIG. 14, the target image 510 displays the text “Printer 04” which indicates the printer 200 to be displayed. Furthermore, the registration button 504 is displayed on the reception screen 500. On the other hand, the size and display position of this registration button 504 are different from those in the example illustrated in FIG. 7. More specifically, the registration button 504 is displayed in a smaller size than in the example illustrated in FIG. 7, in the lower right corner of the reception screen 500.

When the printer 200 to be displayed is not the applicable printer 200, but there is a registration history of the cartridge provision service for this printer 200, this means that the registration for the cartridge provision service for this printer 200 has been cancelled. In this case, when the registration button 504 illustrated in FIG. 7 is displayed again on the reception screen 500, the user may feel aversion to the promotion to register with the cartridge provision service. Therefore, in case that registration for the cartridge provision service is cancelled, the display control unit 105 displays the registration button 504 on the reception screen 500 in a manner that is less noticeable than when registration for the cartridge provision service has never been performed (see FIG. 7).

As described above, in case that the state of the printer 200 as a target goes through the second state from the first state and then becomes the first state again, the display control unit 105 relaxes the restriction on displaying the registration button 504 on the reception screen 500. In this case, a user who has cancelled registration for the cartridge provision service can be prompted to register for the cartridge provision service again.

In addition, the display control unit 105 displays the registration button 504 on the reception screen 500 in different manners depending on whether the state of the printer 200 as a target is the first state without becoming the second state, or whether the state goes through the second state and then becomes the first state again. In this case, it is possible to prevent the user from feeling aversion to the promotion to register with the cartridge provision service, compared to when the registration button 504 is displayed in the same manner regardless of whether the state of the printer 200 as a target has gone through the second state.

Next, the setting as to whether or not to display an image on the reception screen 500 will be described. In the present embodiment, the customization button 1105 (see FIG. 7 and the like) displayed on the reception screen 500 is operated to receive a setting as to whether or not to display an image on the reception screen 500.

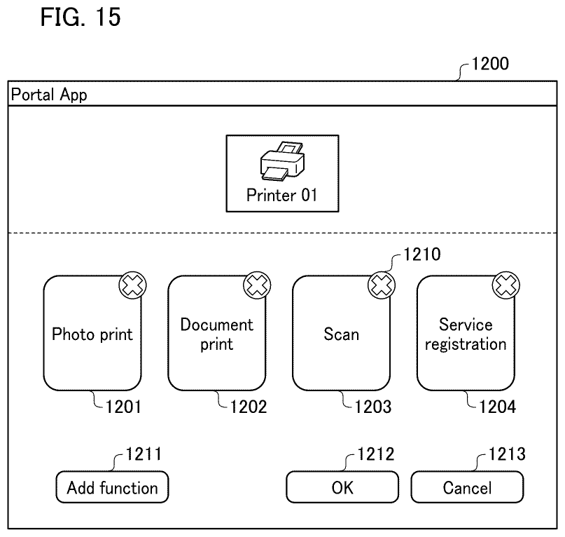

When the user presses the customization button 1105 on the reception screen 500 illustrated in FIG. 7, a customization screen 1200 is displayed on the display unit 119 as illustrated in FIG. 15. The customization screen 1200 is a screen for receiving settings as to whether or not an image is to be displayed on the reception screen 500. The customization screen 1200 displays a photo print image 1201, a document print image 1202, a scan image 1203, a registration image 1204, a hide button 1210, an add button 1211, an OK button 1212, and a cancel button 1213.

The photo print image 1201 is an image targeted for the photo printing function of the printer 200. The document print image 1202 is an image targeted for the document printing function of the printer 200. The scan image 1203 is an image targeted for the scanning function of the printer 200. The registration image 1204 is an image targeted for registration for the cartridge provision service.

The hide button 1210 is a button for receiving that an image is not to be displayed on the reception screen 500. In the illustrated example, the hide button 1210 is displayed in a manner associated with each of the photo print image 1201, the document print image 1202, the scan image 1203, and the registration image 1204.

The add button 1211 is a button for receiving addition of an image to be displayed on the reception screen 500. The OK button 1212 is a button for receiving a determination of a user operation on the customization screen 1200. The cancel button 1213 is a button for receiving cancellation of a user operation on the customization screen 1200.

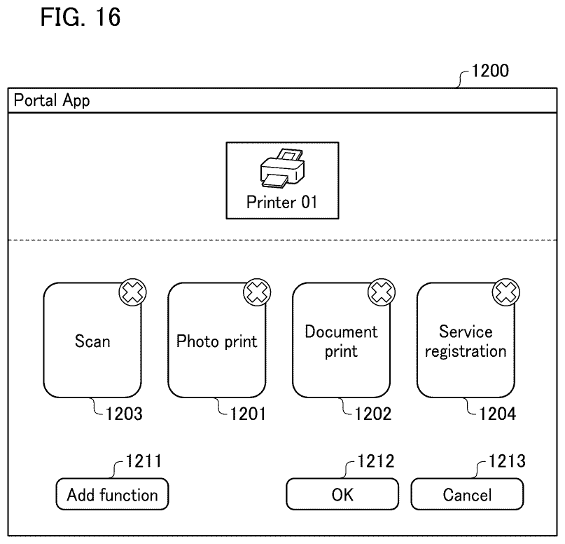

Here, when the user drags and drops the scan image 1203 to the left of the photo print image 1201, the scan image 1203 is displayed to the left of the photo print image 1201 on the customization screen 1200, as illustrated in FIG. 16. When the user presses the OK button 1212 in this state, the scan button 503 is displayed to the left of the photo print button 501 also on the reception screen 500.

Note that, unlike the above-described scan button 503 and the like, the display positions of the registration button 504 and the login button 1004 on the reception screen 500 cannot be changed, and the display positions on the reception screen 500 may be fixed. Furthermore, the display positions of the registration button 504 and the login button 1004 on the reception screen 500 may be changed in the same manner as the scan button 503 described above.

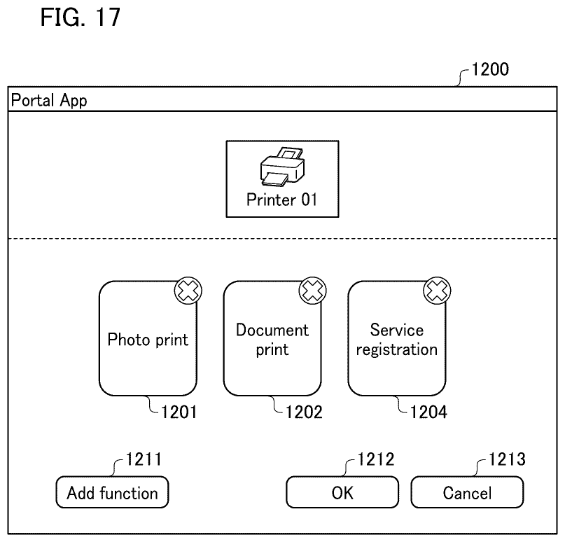

Furthermore, when the user presses the hide button 1210 associated with the scan image 1203 while the customization screen 1200 illustrated in FIG. 15 is displayed, the scan image 1203 becomes hidden, as illustrated in FIG. 17. When the user presses the OK button 1212 in this state, the scan button 503 becomes hidden also on the reception screen 500. That is, when the user presses the hide button 1210, the setting reception unit 104 receives the instruction that an image related to the function associated with the pressed hide button 1210 will not be displayed on the reception screen 500. Then, the display control unit 105 displays the reception screen 500 to reflect the settings received by the setting reception unit 104.

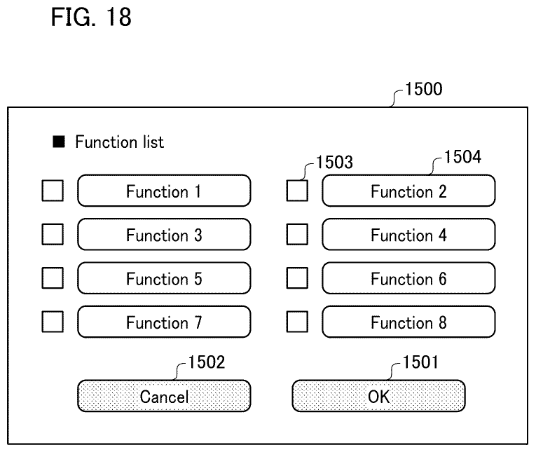

Furthermore, when the user presses the add button 1211 while the customization screen 1200 illustrated in FIG. 15 is being displayed, a selection screen 1500 is displayed on the display unit 119 as illustrated in FIG. 18. The selection screen 1500 is a screen for receiving addition of an image to be displayed on the reception screen 500. The selection screen 1500 displays a function display section 1504, a reception section 1503, an OK button 1501, and a cancel button 1502.

The function display section 1504 is an image showing the name of the function of the printer 200. The functions to be displayed in the function display section 1504 are functions of the printer 200 that are not displayed on the reception screen 500. The function display section 1504 may be provided for functions provided to the user when the login button 1004 is pressed. The reception section 1503 is an image for receiving addition of an image to be displayed on the reception screen 500. The reception sections 1503 are displayed in association with the respective function display sections 1504. The OK button 1501 is a button for receiving a determination of a user operation on the selection screen 1500. The cancel button 1502 is a button for receiving cancellation of a user operation on the selection screen 1500.

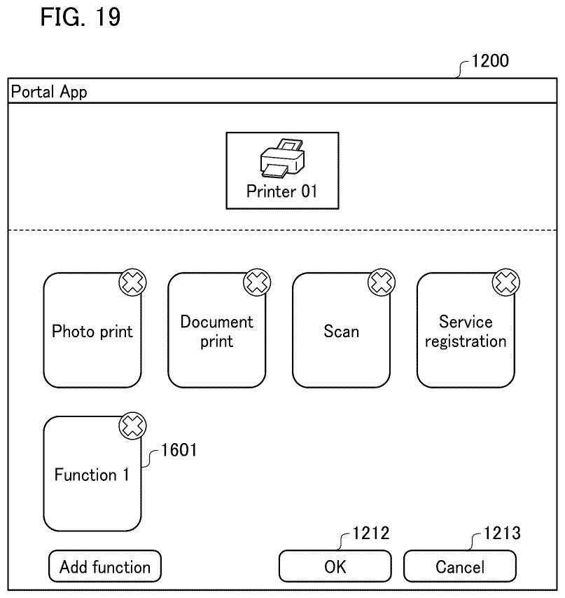

When the user selects the reception section 1503 associated with the function display section 1504 showing the text “Function 1” on the selection screen 1500 and presses the OK button 1501, a function image 1601 is displayed on the customization screen 1200, as illustrated in FIG. 19. The function image 1601 is an image targeted for the “Function 1” shown in the function display section 1504 selected on the selection screen 1500. Although not illustrated, in this state, when the user selects the OK button 1212 on the customization screen 1200, a button for receiving “Function 1” is displayed on the reception screen 500.

In addition, in case that the hide button 1210 associated with the registration image 1204 is pressed on the customization screen 1200 and then the OK button 1212 is pressed, the setting reception unit 104 writes “x” into the display setting 1024 of the status management table (see FIG. 6). In this case, regardless of whether or not the printer 200 to be displayed is the applicable printer 200, a negative result is obtained in S202 of the image determination process (see FIG. 11). Therefore, regardless of whether or not the printer 200 to be displayed is the applicable printer 200, neither the registration button 504 nor the login button 1004 is displayed on the reception screen 500.

As described above, in the present embodiment, there are cases where the setting reception unit 104 has received that the registration button 504 is not to be displayed. In this case, even in case that it is specified from the target identification information that the state of the printer 200 as a target is the second state, the display control unit 105 restricts the display of the login button 1004 on the reception screen 500.

In this case, the user does not need to set the login button 1004 not to be displayed on the reception screen 500.

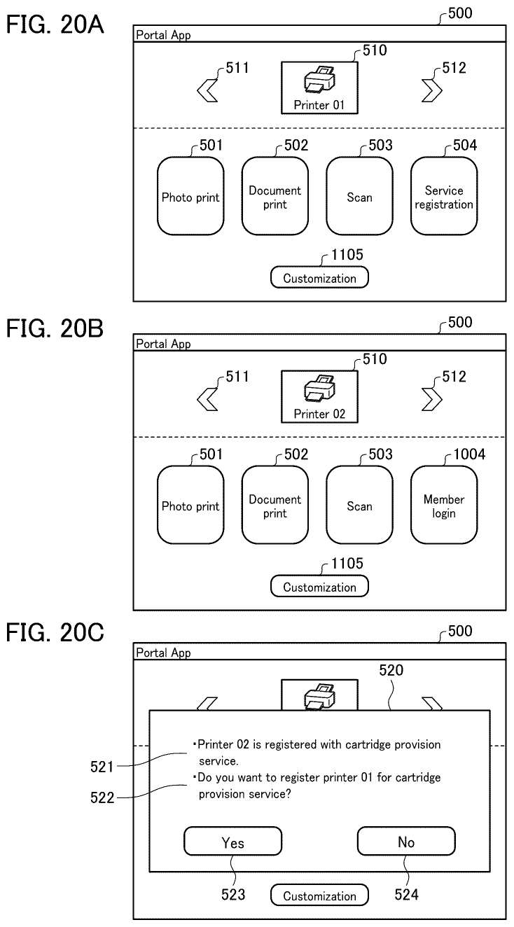

FIGS. 20A to 20C are diagrams illustrating the reception screen 500 for each printer 200. In the following, a case will be described in which the printer 200 with the apparatus ID 1021 (see FIG. 6) of “P01” is not the applicable printer 200, but the printer 200 with the apparatus ID 1021 of “P02” is the applicable printer 200.

In the following description, it is assumed that the printer 200 with the apparatus ID 1021 of “P01” and the printer 200 with the apparatus ID 1021 of “P02” are owned by the same user.

In case that the reception screen 500 for the printer 200 with the apparatus ID 1021 of “P01” is displayed, the image determination process for this printer 200 (see FIG. 11) is performed. In the image determination process for the printer 200 with the apparatus ID 1021 of “P01,” affirmative results are obtained in S201 and S202, and negative results are obtained in S204 and S205. In this case, on the reception screen 500 for the printer 200 with the apparatus ID 1021 of “P01,” as illustrated in FIG. 20A, the login button 1004 is not displayed, but the registration button 504 is displayed. In addition, on this reception screen 500, the target image 510 displays the text “Printer 01” which indicates the printer 200 to be displayed.

Here, when the user presses the next button 512, an image determination process is performed for the printer 200 with the apparatus ID 1021 of “P02” next to “P01.” In the image determination process for the printer 200 with the apparatus ID 1021 of “P02,” affirmative results are obtained in S201, S202, and S204. In this case, on the reception screen 500 for the printer 200 with the apparatus ID 1021 of “P02,” as illustrated in FIG. 20B, the registration button 504 is not displayed, but the login button 1004 is displayed. In addition, on this reception screen 500, the target image 510 displays the text “Printer 02” which indicates the printer 200 to be displayed.

Furthermore, in case that the previous button 511 on the reception screen 500 illustrated in FIG. 20B is pressed, the display control unit 105 displays the reception screen 500 illustrated in FIG. 20A again.

In addition, when the registration button 504 is pressed while the reception screen 500 (see FIG. 20A) for the printer 200 with the apparatus ID 1021 of “P01” is being displayed, the display control unit 105 displays a notification image 520, as illustrated in FIG. 20C.

The notification image 520 is an image for notifying the user of information about a printer 200 that is different from the printer 200 to be displayed among the printers 200 owned by the user. The notification image 520 includes a state notification section 521, a continuation confirmation section 522, an affirmative section 523, and a negative section 524.

The state notification section 521 is an image that notifies the user of the state of a printer 200 that is different from the printer 200 to be displayed, as a target, among the printers 200 owned by the user. In the illustrated example, the state notification section 521 indicates that the state of the printer 200 as a target with the apparatus ID 1021 of “P02” is registered in the cartridge provision service. More specifically, the state notification section 521 displays the text “Printer 02 is registered with the cartridge provision service.”

The continuation confirmation section 522 is an image that confirms with the user whether or not to continue the process of registering the printer 200 to be displayed for the cartridge provision service. In the illustrated example, the continuation confirmation section 522 displays the text “Do you want to register Printer 01 for the cartridge provision service?.”

The affirmative section 523 is a button for continuing the process of registration with the cartridge provision service. In case that the user presses the affirmative section 523, the registration reception process (see FIG. 8) is started.

The negative section 524 is a button for canceling the process of registration with the cartridge provision service. In case that the user presses the negative section 524, the registration reception process is not started, and the reception screen 500 illustrated in FIG. 20A is displayed again on the display unit 119.

As described above, in case that it is specified from the target identification information that the state of a first information processing apparatus as a target is the first state, the display control unit 105 does not restrict the display of the registration button 504 for the first information processing apparatus on the reception screen 500. In addition, in case that it is specified from the target identification information that the state of a second information processing apparatus as a target is the second state, the display control unit 105 restricts the display of the registration button 504 for the second information processing apparatus on the reception screen 500. An example of the first information processing apparatus includes the printer 200 with the apparatus ID 1021 of “P01.” An example of the second information processing apparatus includes the printer 200 with the apparatus ID 1021 of “P02.”

In this case, information according to the state of the printer 200 to be displayed as a target can be provided to the user.

In addition, in case that the registration button 504 for the first information processing apparatus is selected, the display control unit 105 causes the display unit 119 to display an image indicating that the state of the second information processing apparatus as a target is the second state. Examples of images indicating that the state of the second information processing apparatus as a target is the second state include the notification image 520 and the state notification section 521.

In this case, it is possible to allow the user to easily distinguish between the state of the first information processing apparatus as a target and the state of the second information processing apparatus as a target.

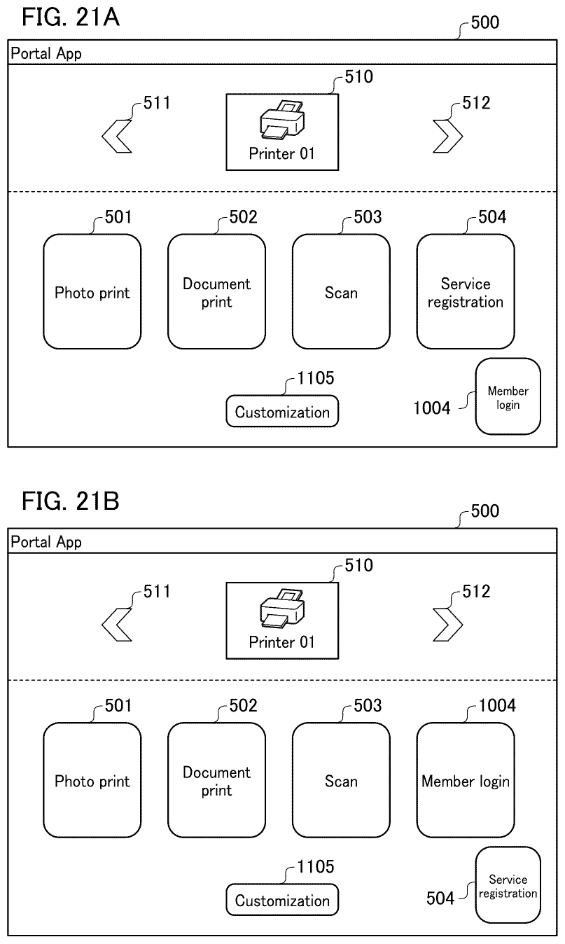

FIGS. 21A and 21B are diagrams illustrating a modification example of the reception screen 500.

In the above example, it has been described that the login button 1004 is not displayed on the reception screen 500 in case that the printer 200 to be displayed is not the applicable printer 200. Also, although it has been described that the registration button 504 is not displayed on the reception screen 500 in case that the printer 200 to be displayed is the applicable printer 200, the present disclosure is not limited thereto.

In case that the printer 200 to be displayed is not the applicable printer 200, the reception screen 500 may display the login button 1004 in addition to the display of the registration button 504, as illustrated in FIG. 21A.

Furthermore, in case that the printer 200 to be displayed is the applicable printer 200, the reception screen 500 may display the registration button 504 in addition to the display of the login button 1004, as illustrated in FIG. 21B.

Here, the display manner of the registration button 504 on the reception screen 500 differs depending on whether or not the printer 200 to be displayed is the applicable printer 200. More specifically, in case that the printer 200 to be displayed is the applicable printer 200, the display size of the registration button 504 is smaller and the registration button 504 is displayed in a less noticeable position on the reception screen 500 than in case that the printer 200 to be displayed is not the applicable printer 200.

Furthermore, the display manner of the login button 1004 on the reception screen 500 differs depending on whether or not the printer 200 to be displayed is the applicable printer 200. More specifically, in case that the printer 200 to be displayed is not the applicable printer 200, the display size of the login button 1004 is smaller and the login button 1004 is displayed in a less noticeable position on the reception screen 500 than in case that the printer 200 to be displayed is the applicable printer 200.

As described above, the display control unit 105 causes the registration button 504 to be displayed on the reception screen 500 in different manners depending on whether the state specified from the target identification information is the first state or the second state. Even in this case, it is possible to reduce the sense of discomfort felt by the user compared to when the registration button 504 is displayed on the display unit 119 in the same manner when the state of the printer 200 as a target is the first state and when it is the second state.

In addition, the display control unit 105 causes the login button 1004 to be displayed on the reception screen 500 in different manners depending on whether the state specified from the target identification information is the first state or the second state. Even in this case, it is possible to reduce the sense of discomfort felt by the user compared to when the login button 1004 is displayed on the display unit 119 in the same manner when the state of the printer 200 as a target is the first state and when it is the second state.

In addition, in a modification example, the registration button 504 may be displayed in any position as long as it is displayed in a different position depending on whether the state of the printer 200 to be displayed as a target is the first state or the second state. Even in this case, in the second state, the registration button 504 is displayed in a position different from the familiar position of the registration button 504 in the first state, and therefore is less noticeable.

In addition, in a modification example, the login button 1004 may be displayed in any position as long as it is displayed in a different position depending on whether the state of the printer 200 to be displayed as a target is the first state or the second state. Even in this case, the login button 1004 can be presented to the user in a different manner between the first state and the second state.

Also, in the present embodiment, it has been described that the login button 1004 is displayed on the reception screen 500 in case that the printer 200 to be displayed is the applicable printer 200, but the present disclosure is not limited thereto.

In case that the printer 200 to be displayed is the applicable printer 200, the display control unit 105 may display a cancel button image on the reception screen 500 to receive cancellation of the registration for the cartridge provision service for this printer 200. In case that the user presses the cancel button image, the registration for the cartridge provision service for the printer 200 to be displayed may be cancelled. Note that the display control unit 105 may not display the cancel button image on the reception screen 500 in case that the printer 200 to be displayed is not the applicable printer 200. In addition, the display control unit 105 may display the cancel button image in a smaller size and in a less noticeable position on the reception screen 500 in case that the printer 200 to be displayed is not the applicable printer 200 than in case that the printer 200 to be displayed is the applicable printer 200. Furthermore, in case that the cancel button image is displayed, the display control unit 105 may or may not display the login button 1004 on the reception screen 500.

In addition, in the present embodiment, it has been described that the terminal apparatus 100 acquires information indicating whether or not the printer 200 to be displayed is an applicable printer 200 from the printer 200 to be displayed (see S203 in FIG. 11), but the present disclosure is not limited thereto. The information indicating whether or not the printer 200 is an applicable printer 200 may be managed in the management server 300. The terminal apparatus 100 may then acquire, from the management server 300, information indicating whether or not the printer 200 is an applicable printer 200. That is, the terminal apparatus 100 may acquire, from any apparatus, information indicating whether or not the printer 200 is an applicable printer 200.

Furthermore, in the present embodiment, the service that is the target of management by the state management system 1 as to whether or not it is registered is the cartridge provision service, but the present disclosure is not limited thereto. The services that are the target of management by the state management system 1 may be any services related to the printer 200, such as a service that accumulates points in response to printing by the printer 200 or ink replacement for the printer 200, for example.

In addition, in the present embodiment, whether or not the registration button 504 and the login button 1004 are displayed is determined depending on whether or not the hide button 1210 for the registration image 1204 (see FIG. 15) is pressed, but the present disclosure is not limited thereto.

A login image for a user to log in to the state management system 1 may be displayed on the customization screen 1200, and the hide button 1210 may be displayed in association with this login image. Then, in case that the hide button 1210 associated with the login image is pressed, the display control unit 105 may not display either the registration button 504 or the login button 1004 on the reception screen 500, regardless of whether or not the printer 200 is registered with the service.

In addition, in the present embodiment, it has been described that the display control unit 105 displays, on the reception screen 500, information according to whether or not a specific service for the printer 200 is registered, but the present disclosure is not limited thereto.

For example, there may be a plurality of services for the printer 200. In this case, in case that no service is registered for the printer 200 to be displayed, the display control unit 105 may display the registration button 504 on the reception screen 500 without displaying the login button 1004. In addition, in case that there are registered services and unregistered services for the printer 200 to be displayed, the display control unit 105 may display both the registration button 504 and the login button 1004 on the reception screen 500. Furthermore, in case that all services have been registered for the printer 200 to be displayed, the display control unit 105 may display the login button 1004 on the reception screen 500 without displaying the registration button 504.

Also, specific services for the printer 200 may be provided in stages. In this case, the display control unit 105 may display, on the reception screen 500, information corresponding to the stage at which a specific service is registered. In this case, the above-mentioned first and second states may each be states in which specific services for the printer 200 are registered at different stages.

Furthermore, the states of the printer 200 as a target, such as the first state and the second state, are not limited to the state of service registration for the printer 200. For example, a state in which a specific function related to the printer 200 has been used may be the first state, and a state in which the specific function has not been used may be the second state. This specific function may be available without requiring registration. In this case, the display control unit 105 may display, on the reception screen 500, a display item that can execute a process for using a specific function, depending on whether the state of the printer 200 as a target is the first state or the second state. In other words, the state used as a criterion for the display control unit 105 to determine which image to display on the reception screen 500 may be any state as long as it is a state of the printer 200 as a target.

Furthermore, the reception screen 500 is not limited to the above example. The reception screen 500 may be any image that receives an operation related to the use of the information processing apparatus, such as an image that receives confirmation of the job status of the printer 200, for example. Furthermore, the reception screen 500 may be a screen on which at least the registration button 504 is displayed, or may be a screen on which at least the login button 1004 is displayed.

The registration button 504 is an image that receives registration for a cartridge provision service, which is a service related to the use of the printer 200. Therefore, the registration button 504 can be regarded as an image that receives operations related to the use of the information processing apparatus. That is, the screen on which at least the registration button 504 is displayed can be regarded as a reception screen for receiving operations related to the use of the information processing apparatus.

The login button 1004 is an image that receives the display of the registration status screen 800 (see FIG. 10) that shows the registration status for the cartridge provision service, which is a service related to the use of the printer 200. Therefore, the login button 1004 can also be regarded as an image that receives operations related to the use of the information processing apparatus. That is, the screen on which at least the login button 1004 is displayed can be regarded as a reception screen for receiving operations related to the use of the information processing apparatus.

In the present embodiment, it has been described that the information processing apparatus that is the target of management by the state management system 1 is the printer 200, but the present disclosure is not limited thereto. The target of management by the state management system 1 may not be the printer 200, as long as it is an information processing apparatus. The printer 200 of the present embodiment can also be regarded as an information processing apparatus that operates through the operation of the terminal apparatus 100 by the user. However, the printer 200 may have a display apparatus that displays an image that receives user operations, and may operate in response to the user operations on the image.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

What is claimed is:

1. A non-transitory computer-readable storage medium storing one or more programs configured to cause one or more computers to perform a method, the method comprising:
acquiring registration information indicating whether or not an information processing apparatus external to a terminal apparatus is registered with a specific service provided for the information processing apparatus, the specific service being a service provided by using an external server system;
performing control on a display of the terminal apparatus to display a first screen including a first selection item for instructing the information processing apparatus to execute a predetermined operation and a second selection item for instructing the information processing apparatus to execute a specific process for registering with the specific service in case that the registration information indicates that the information processing apparatus is not registered with the specific service; and
performing control on the display to display a second screen including the first selection item and not including the second selection item in case that the registration information indicates that the information processing apparatus is registered with the specific service.

2. The non-transitory computer-readable storage medium according to claim 1, wherein the specific process for registering with the specific service includes a transmission process of transmitting identification information of the information processing apparatus to the external server system for registration with the specific service.

3. The non-transitory computer-readable storage medium according to claim 1, wherein the second screen includes a third selection item that issues an instruction to execute a process for logging in to display information related to the specific service.

4. The non-transitory computer-readable storage medium according to claim 3, wherein, in case that the information processing apparatus is an apparatus that is not able to be registered with the specific service, the one or more computers perform control on the display to display a third screen in which the first selection item is displayed and neither the second selection item nor the third selection item is displayed.

5. The non-transitory computer-readable storage medium according to claim 3,
wherein the one or more computers are further set a selection item to be displayed on a screen among a plurality of selection items including the first selection item and the second selection item based on a user operation, and
wherein, in case that the first selection item is set as the selection item to be displayed on the screen and the second selection item is not set, the one or more computers perform control to display a third screen in which the first selection item is displayed and the third selection item is not displayed, even when the registration information indicates that registration for the specific service is in progress.

6. The non-transitory computer-readable storage medium according to claim 3, wherein a position of the third selection item displayed on the second screen is the same as a position of the second selection item displayed on the first screen.

7. The non-transitory computer-readable storage medium according to claim 1,
wherein the information processing apparatus is capable of registering with a plurality of services provided for the information processing apparatus using the external server system, and
wherein the one or more computers cause the second screen to be displayed on the display at least when registration for the specific service is in progress.

8. The non-transitory computer-readable storage medium according to claim 1, wherein the one or more computers acquire the registration information from the information processing apparatus.

9. The non-transitory computer-readable storage medium according to claim 1, wherein the information processing apparatus is a printer.

10. The non-transitory computer-readable storage medium according to claim 1, wherein the specific service is a service related to a delivery of a recording material used in printing.

11. The non-transitory computer-readable storage medium according to claim 1, wherein the first selection item is a selection item for issuing a print instruction to the information processing apparatus.

12. The non-transitory computer-readable storage medium according to claim 1, wherein the one or more computers perform control on the display to display a registration screen for registering with the specific service when the second selection item is selected while the first screen is being displayed.

13. The non-transitory computer-readable storage medium according to claim 1,
wherein the one or more computers further
manage history information indicating whether the information processing apparatus has been registered with the specific service,
perform control to display the second selection item in a first display mode when the registration information indicates that the information processing apparatus is not registered with the specific service and the history information indicates that the information processing apparatus has never been registered with the specific service, and
display the second selection item in a second display mode different from the first display mode when the registration information indicates that the information processing apparatus is not registered with the specific service and the history information indicates that the information processing apparatus has been registered with the specific service.

14. The non-transitory computer-readable storage medium according to claim 13, wherein the second display mode is smaller in size than the first display mode.

15. A method comprising:
acquiring registration information indicating whether or not an information processing apparatus external to a terminal apparatus is registered with a specific service provided for the information processing apparatus, the specific service being a service provided by using an external server system;
performing control on a display of the terminal apparatus to display a first screen including a first selection item for instructing the information processing apparatus to execute a predetermined operation and a second selection item for instructing the information processing apparatus to execute a specific process for registering with the specific service in case that the registration information indicates that the information processing apparatus is not registered with the specific service; and
performing control on the display to display a second screen including the first selection item and not including the second selection item in case that the registration information indicates that the information processing apparatus is registered with the specific service.

16. A terminal apparatus comprising:
at least one memory storing a program; and
at least one processor that executes the stored program, which cause the at least one processor to:
acquire registration information indicating whether or not an information processing apparatus external to the terminal apparatus is registered with a specific service provided for the information processing apparatus, the specific service being a service provided by using an external server system,
perform control on a display of the terminal apparatus to display a first screen including a first selection item for instructing the information processing apparatus to execute a predetermined operation and a second selection item for instructing the information processing apparatus to execute a specific process for registering with the specific service in case that the registration information indicates that the information processing apparatus is not registered with the specific service, and
perform control on the display to display a second screen including the first selection item and not including the second selection item in case that the registration information indicates that the information processing apparatus is registered with the specific service.
